(19) United States
(12) Patent Application Publication
(10) Pub. No.: US 2014/0316025 A1
(43) Pub. Date: Oct. 23, 2014

(54) Lightweight Gypsum Composition

(71) Applicant: Michael Rodgers, Madison, MS (US)

(72) Inventor: Michael Rodgers, Madison, MS (US)

(21) Appl. No.: 13/866,741

(22) Filed: Apr. 19, 2013

(51) Int. Cl. C04B 16/08; C04B 16/02; C04B 16/04; C04B 14/00

(52) U.S. Cl. CPC C04B 16/08; C04B 14/00; C04B 16/02; C04B 16/04
USPC 521/146; 524/8; 524/7; 524/6; 523/447

(57) ABSTRACT

A gypsum composition for making lightweight blocks, panels, boards, coatings or other user defined shapes that are specially beneficial to the building construction industry. The novel gypsum composition comprises one to five volume percent starch; one to five volume percent crystalline silica; one to ten volume percent cellulose; ten to eighty volume percent gypsum; and ten to eighty volume percent Styrofoam particles, hard plastic particles, rubber particles or a combination thereof, wherein the particles have an average particle size in a range of about 15 to about 150 mesh. The particles can be from a virgin source, a recycled source or a combination thereof.

### CROSS-REFERENCES TO RELATED APPLICATIONS

NOT APPLICABLE

### STATEMENT REGARDING FEDERAL SPONSORED RESEARCH OR DEVELOPMENT

NOT APPLICABLE

### NAMES OF PARTIES TO A JOINT RESEARCH AGREEMENT

NOT APPLICABLE

### REFERENCE TO A SEQUENCE LISTING

NOT APPLICABLE

### BACKGROUND OF INVENTION

(1) Field of Invention

The present invention relates generally to plaster compositions. More particularly, the present invention relates to a lightweight plaster composition comprised primarily of gypsum and Styrofoam, hard plastics, rubber or a combination thereof to manufacture plaster products.

(2) Background of Invention

Gypsum is a naturally occurring form of calcium sulphate, in the form of stable dehydrate (CaSo₄.2H₂O). The term “gypsum” as used herein, means calcium sulphate in the stable dehydrate state, and includes the naturally occurring mineral, synthetically derived equivalents, and the dehydrate material formed by the hydration of stucco (calcium sulphate hemihydrates) or anhydrite. The properties of gypsum make it highly desirable for use in industrial and building plasters and other building products, including gypsum wallboard. It is a plentiful and inexpensive raw material which, through successive steps of dehydration and rehydration, can be cast, molded or otherwise formed into useful shapes. A good example would be gypsum wallboard, also known as plasterboard or drywall, wherein a gypsum core is sandwiched between paper or cardboard cover sheets.

A typical gypsum composition, whether used in wallboard or other forms, is comprised of gypsum, a plasticizer, a foaming agent, finely ground gypsum crystal (as an accelerator), EDTA, starch or other chelates (as a retarder), a wax emulsion or silanes (for lower water absorption) and water. Other variations of the typical gypsum compositions include fibers to offset the brittle nature of the gypsum, vermiculite to improve mildew and fire resistance or a combination of both. Thereafter, the typical gypsum composition is formed into the desired shape. In one instance, sandwiching a core of a wet typical gypsum composition between two sheets of heavy paper or fiberglass mats and then dried creates a drywall panel. In another instance, a typical gypsum composition is poured into a form and then dried to create molded plaster architectural features for the construction industry. However, the weight of such a typical gypsum composition are significant and limit their use to structures that can support the resulting hardened mix.

### BRIEF SUMMARY OF THE INVENTION

The present invention is a lightweight and durable gypsum composition. The lightweight and durable gypsum composition replaces a significant volumetric amount of the gypsum of a traditional gypsum composition with Styrofoam, plastic, rubber or a combination thereof. It is further contemplated that the Styrofoam, plastic, rubber or combination thereof used to replace a significant amount of gypsum can be from a virgin source, a recycled source or a combination thereof. In a preferred embodiment, the Styrofoam, plastic, rubber or a combination thereof replacing the gypsum has an average particle size in the range of about 15 mesh to about 150 mesh. In a preferred embodiment, the average particle size is a substantially uniform mesh size between about 15 mesh to about 150 mesh. Use of such a novel gypsum composition can reduce the weight of a comparable drywall panel or gypsum formed object by as much as approximately 77% by using plastic, rubber or a combination thereof. Greater weight reductions can be achieved with the use of Styrofoam.

### BRIEF DESCRIPTION OF THE SEVERAL VIEWS OF THE DRAWINGS

None.

### DETAILED DESCRIPTION OF THE PREFERRED EMBODIMENTS

As required, detailed embodiments of the present invention are disclosed herein; however, it is to be understood that the disclosed embodiments are merely exemplary of the invention that may be embodied in various and alternative forms. Functional details disclosed herein are not to be interpreted as limiting, but merely as a basis for the claims and as a representative basis for teaching one skilled in the art to variously employ the present invention. Certain terminology will be used in the following description for convenience and reference only and not for purposes of limitation.

The present invention comprises a lightweight gypsum composition that can be formed into blocks, panels, boards, coatings or other user defined shapes that are specially beneficial to the building construction industry. In a preferred embodiment, the lightweight gypsum composition comprises one (1) to five (5) volume percent starch; one (1) to five (5) volume percent crystalline silica; one (1) to ten (10) volume percent cellulose; ten (10) to eighty (80) volume prevent gypsum; and ten (10) to eighty (80) percent closed cell Styrofoam particles. The closed cell Styrofoam particles have an average size in a range of about fifteen (15) mesh to about one hundred and fifty (150) mesh and an average bulk density of about one and one half pounds per cubic foot (1½ lbs/cult). The Styrofoam particles can be from a virgin source, a recycled source or a combination thereof.

In another preferred embodiment, the lightweight gypsum composition comprises one (1) to five (5) volume percent starch; one (1) to five (5) volume percent crystalline silica; one (1) to ten (10) volume percent cellulose; ten (10) to eighty (80) volume prevent gypsum; and ten (10) to eighty (80) volume percent hard plastic particles. The hard plastic particles have an average size in a range of about fifteen (15) mesh to about one hundred and fifty (150) mesh and an average bulk density of about twenty-three pounds per cubic foot (23 lbs/cult). Hard plastic particles as used above means particles of polystyrene, ABS, polycarbonate, polyolefins, polyvinyl chloride, polyurethane, phenolic, urea-formaldehyde, epoxy or a combination thereof. The hard plastic particles can be from a virgin source, a recycled source or a combination thereof.

In yet another preferred embodiment, the lightweight gypsum composition comprises one (1) to five (5) volume percent starch; one (1) to five (5) volume percent crystalline silica; one (1) to ten (10) volume percent cellulose; ten (10) to eighty (80) volume prevent gypsum; and ten (10) to eighty (80) percent rubber particles. The rubber particles have an average size in a range of about fifteen (15) mesh to about one hundred and fifty (150) mesh and an average bulk density of about twenty-three pounds per cubic foot (23 lbs/cult). The rubber particles can be from a virgin source, a recycled source or a combination thereof.

What is claimed is:

1. A gypsum composition for making lightweight drywall panels, comprising:
One to five volume percent starch;
One to five volume percent crystalline silica;
One to ten volume percent cellulose;
Ten to eighty volume percent gypsum; and
Ten to eighty volume percent closed cell Styrofoam particles, wherein the closed cell Styrofoam particles have an average particle size in a range of about 15 to about 150 mesh and an average bulk density of about 1.5 pounds per cubic foot.

2. A gypsum composition for making lightweight drywall panels, comprising:
One to five volume percent starch;
One to five volume percent crystalline silica;
One to ten volume percent cellulose;
Ten to eighty volume percent gypsum; and
Ten to eighty volume percent hard plastic particles, wherein the hard plastic particles have an average particle size in a range of about 15 to about 150 mesh and an average bulk density of about 23 pounds per cubic foot.

3. The gypsum composition for making lightweight drywall panels as claimed in claim 2, wherein said hard plastic particles are selected from the group consisting of polystyrene, ABS, polycarbonate, polyolefins, polyvinyl chloride, polyurethane, phenolic, urea-formaldehyde, epoxy and a combination thereof.

4. A gypsum composition for making lightweight drywall panels, comprising:
One to five volume percent starch;
One to five volume percent crystalline silica;
One to ten volume percent cellulose;
Ten to eighty volume percent gypsum; and
Ten to eighty volume percent rubber particles, wherein the rubber particles have an average particle size in a range of about 15 to about 150 mesh and an average bulk density of about 23 pounds per cubic foot.
